(19) United States
(12) Patent Application Publication
(10) Pub. No.: US 2019/0080312 A1
(43) Pub. Date: Mar. 14, 2019

(54) SYSTEM AND METHOD FOR IMPROVED POINT OF SALE AND CRM NETWORK INTERFACE

(71) Applicant: ONVOCAL, INC., Danvers, MA (US)

(72) Inventors: Charles Douglas Yeager, Austin, TX (US); Pichrachana Sun, Ashby, MA (US); Andrew Molloy, Salem, NH (US); William E. Bachrach, West Newbury, MA (US)

(73) Assignee: ONVOCAL, INC., Danvers, MA (US)

(21) Appl. No.: 16/128,824

(22) Filed: Sep. 12, 2018

Related U.S. Application Data
(60) Provisional application No. 62/557,821, filed on Sep. 13, 2017.

(51) Int. Cl. G06Q 20/32; G06Q 20/36; G06Q 30/02

(52) U.S. Cl. CPC G06Q 20/3223; G06Q 30/0233; G06Q 20/3674; G06Q 20/3278

(57) ABSTRACT

An interface solution through API or SDK integrations between mobile device wallet system/application and Point Of Sale systems that implements an “out of band” channel, adjunct but not a part of the traditional payment network but with access to payment network information, for secure communications between merchants and users. The disclosed system and method is a solution, using an app with digital credentials, that provides technical integration of a system and method for communication between wallet systems and devices and CRM systems and networks.

### CROSS-REFERENCE TO RELATED APPLICATION DATA

The present application claims priority to U.S. Provisional Patent Application No. 62/557,821 filed on Sep. 13, 2017, which is hereby incorporated by reference in its entirety.

### FIELD

The present disclosure relates to interfaces to secure computer-based digital wallets and applications and Point Of Sale terminals.

### BACKGROUND

There are many payment card acceptance terminals, and a variety of types of such terminals, that are owned/deployed by businesses (typically referred to as “POS” or Point Of Sale terminals). There are vast numbers of payment card holders. Tracking payment card holders who purchase items via POS terminals is an advantage to a business.

Payment cards have made a transition in recent years to take a digital form from a physical plastic form. Digital forms of payment cards can be classified as any payment card that was “provisioned” digitally (i.e., not printed at a card producing factory, but personalized on demand by the customer through a digital device like a mobile phone). Some embodiments of a digital payment card may be the mobile phone itself using technologies such as NFC (Near Field Communication) or MST (Magnetic Stripe Transmission), as well as hardware dongles or attachments both wired and wirelessly connected to a mobile device. Digital payment cards owned and used by a user may be electronically managed using an electronic wallet, such as may be implemented in application software on the user's mobile device.

Digital payment cards are generally used on or in conjunction with mobile application software, including digital wallet applications and/or banking applications, that reside on the mobile device. Digital information generated, communicated and processed in a digital payment transaction using mobile applications with a business is important information for a business to process and manage, for example, in order for that business to understand its customer's activities and generate returning payment card holders and therefore returning payments at the business's POS terminals.

Systems for managing customer-related and digital transaction information are known, typically referred to as CRM or Customer Relationship Management systems or software. CRM systems may be used to collect, store, manage and otherwise process customer-related digital information, and could be used to collect, store, manage and otherwise process customer information related to digital payment cards and transactions.

There are many different types of POS software and also many different types of CRM software that operate in many businesses. Making changes to POS and CRM software for businesses both large and small is very difficult or impossible. Many of the software components in POS and CRM systems do not support tracking individual payment card holders and being able to communicate with the payment card holder digitally after the transaction. Known systems do not have access to or provide availability to the digital information that may be useful information for interfacing with those payment card holders after payments are made at the POS terminals (e.g. to re-market or re-message communications to the digital payment card holders).

It is generally not an option to modify POS terminal operation to be more flexible to provide access to information that may be available, or to reconfigure current Point of Sale systems and services to integrate optimally or flexibly with known CRM systems. Instead, useful information obtainable from POS systems may have to be alternatively, e.g. manually, obtained, which may result in errors in the information obtained and entered into systems, limited ability properly track and process such information, and the human interfacing to gather such information is likely to be met by resistance from the payment card holders. Additionally, security and privacy concerns arise in the gathering or management of any consumer information. Furthermore, advantageous aspects of CRM systems may not be implemented due to inflexibility and limited access to system interfaces.

### SUMMARY

The present disclosure provides an interface solution through API or SDK integrations between mobile device wallet system/application and Point Of Sale systems that implements an “out of band” channel, adjunct but not a part of the traditional payment network but with access to payment network information, for secure communications between merchants and users. The disclosed system and method is a solution, using an app with digital credentials, that provides easier and more efficient technical integration of a system and method for communication between wallet systems and devices and CRM systems and networks. The present disclosure provides a system and method that employs a novel architecture for “out of band” communication between payment card holders and businesses and does not require data to be exchanged between, or modifications to be made to, a business' POS or CRM systems to communicate with the card holder.

Aspects of the present disclosure provide an improved POS, CRM network, and systems and methods that overcome technical difficulties associated with communication between different types of POS and CRM software (which are generally not configured for inter-communication and cannot be readily modified by a business implementing the POS and CRM systems or a plurality of differing such systems. Aspects of the present disclosure provide for an interface through Application Programming Interface (API) or Software Development Kit (SDK) integrations between wallet systems and devices and CRM software and systems to enable communication with the users associated with the wallet systems. The disclosure provides a system configured to create a seamless and simple communication bridge between CRM software and systems with a digital wallet system, whether these systems are in the same company or different companies.

The system and methods described herein address the increased desire for seamless communication between different types of CRM software and POS systems and software, and payment card holders and businesses.

An exemplary method for communication using an interface, through API or SDK integrations, between wallet systems and devices and CRM software and systems to enable communication with the users associated with the wallet systems is also provided. According to one aspect, a user has installed and uses a mobile device application to request a digital payment card. A mobile device application is configured to transmit digital card data to a POS terminal through the API software or SDK. The POS terminal may relay card information through a processing network to a Token Service Provider (TSP). The TSP may convert card information to a 1 to 1 mapped set of card information. The TSP may also send mapped payment card data to a card issuer for authorization and receive a response from the card issuer. Further, the TSP may send the approval response to the POS terminal to be displayed on a screen of the POS terminal and the TSP may also send out of band data to a Token Requestor (TR). The out of band data may include Merchant Identifier (MID), Amount of transaction, and the status of approved or declined. The TR may send the out of band data to the mobile device application or SDK on the user mobile device to provide feedback to the card holder on the mobile device about the use associated with the card.

A platform of universal application interfaces may provide interactions enabling user engagement, receiving a notification from an application seeking a response; receiving, from the user by QR code, sound, contactless tap, reply or other interaction to reply to an out of band merchant communication. An interaction platform is provided which independently supports numerous hardware accessories to provide a seamless system comprising services such as payment, audio, near-field communication and other utilities. The system provides for securely-connected devices to transmit a payment token or payment credential of consumer data to a point of sale device to enable auto-enrollment to access a communication bridge that facilitates networked communications between a user and system subscribers, such as merchants, as a result of a payment transaction.

The system and method according to the disclosure provides a seamless and simple interface between POS system provider, and wallet application providers to pass information between these systems. The system may include a Software Development Kit (SDK) or library of functions that plugs into apps including wallet apps, to collect voluntary preference data, identify locations and provide suggestions based on consumer wallet information. The system and method according to the disclosure, together with the enhanced communication methods between merchant systems and consumer/user devices, is a system that can be integrated into a consumer app, which creates an improved network of connections between merchants and consumers.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### DESCRIPTION OF THE DRAWINGS

The present disclosure is described with respect to particular exemplary embodiments thereof and reference is accordingly made to the drawings in which:

FIG. 1 is an overview block diagram illustrating components of a system and method for improved Point Of Sale (POS) terminal and Customer Relationship Management (CRM) system network interface according to the disclosure;

FIG. 2 is a block diagram illustrating data flow and communication between components of a system and method for improved POS and CRM network interface according to the disclosure;

FIG. 3 is a block diagram illustrating data flow and communication between components of a system and method for improved POS and CRM network interface according to the disclosure;

FIG. 4 is a diagram illustrating Token Service Provider (TSP) mapping of digital payment card(s) to card issuer Personal Account Number (PAN);

FIG. 5 is a block diagram illustrating TSP to Token Requestor (TR) out of band transaction data notification in a system and method according to the disclosure;

FIG. 6 is a diagram illustrating TR and SDK signal flow according to the disclosure;

FIG. 7 is a diagram illustrating TR and communication bridge signal flow according to the disclosure;

FIG. 8 illustrates an overview diagram, illustrating a use case of how the system and method according to the disclosure uniquely enables consumers to easily pay at a merchant and easily connect into a merchant program via a communication bridge effected; and

FIG. 9. depicts a notification appearing on a lock screen when an attempt to join a program is made; and an implementation of the standard ability to open the communication bridge according to the disclosure.

### DETAILED DESCRIPTION

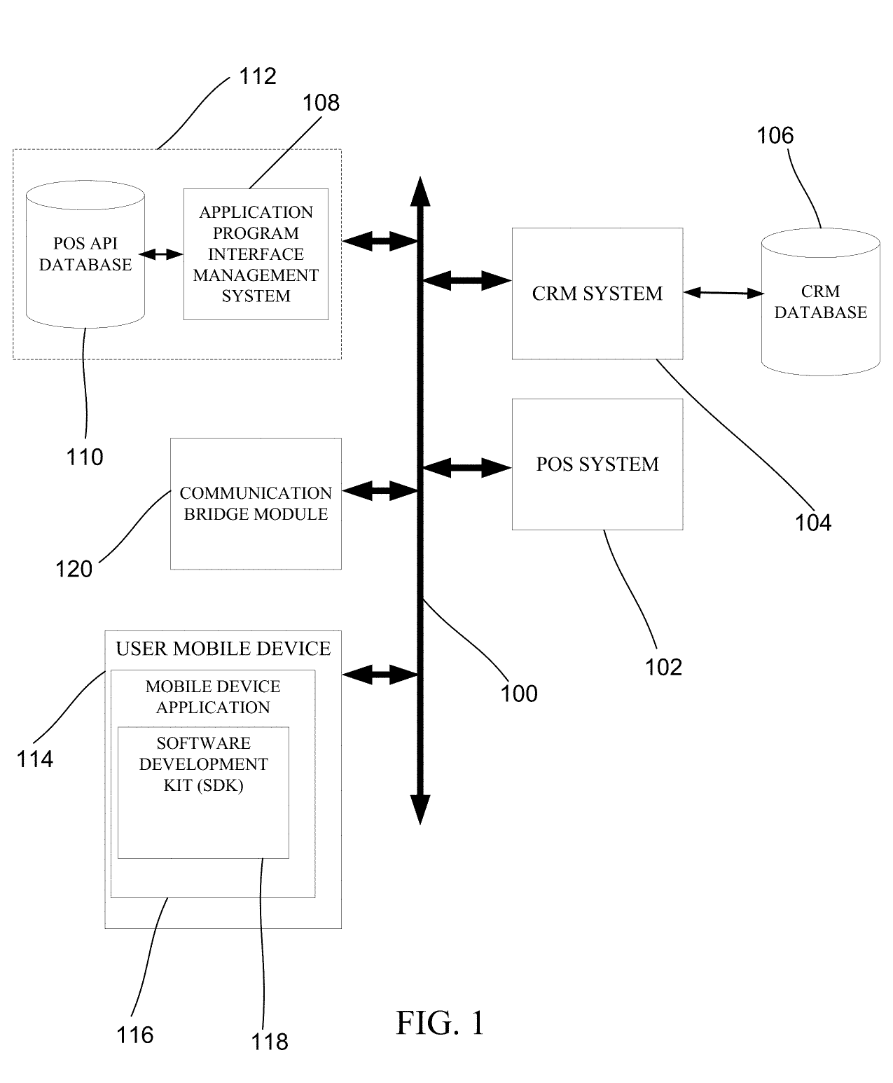

Systems and methods for an improved network integrated between mobile wallet systems and devices and CRM and POS software and systems are illustrate with respect to FIG. 1. An overview block diagram illustrating components of a system and method is provided. A network may be implemented with a bus architecture, represented generally by a bus 100. The bus 100 may include any number of interconnecting buses and bridges depending on the specific application of the network and the overall design constraints. The bus 100 links together various circuits including one or more processors and/or hardware modules described hereinafter. The bus 100 may be hard-wired or wireless, and may also link various other circuits such as timing sources, peripherals, voltage regulators, and power management circuits, which are well known in the art, and therefore, will not be described any further.

Interconnected with the bus 100, in the improved network according to the disclosure, is a Point Of Sale (POS) terminal or system 102, and a Customer Relationship Management (CRM) system 104. The CRM system 104 may include an associated CRM database 106 for storage of information associated with or managed/processed by the CRM system 104. The POS system and/or CRM system 104 may be adapted to store user information associated with different payment card holders. The CRM system 104 may be in communication with at least one CRM database 106 adapted to store information from a plurality of different CRM's.

An Application Program Interface (API) management system 108 may be implemented and interconnected along with an API database system 110 for storage of a plurality of different POS APIs. It may be desirable to provide for management and storage of the plurality of APIs for integration and implementation of functionality as described hereinafter with a plurality of different POS and/or CRM systems having different interface requirements. The API management system 108 and API database system 110 may be implemented as part of a server, such as a Token Requestor (TR) server 112, managing configurations, integration and communications as described in greater detail hereinafter. It should be appreciated that the API management system 108 and interconnected API database system 110 may alternately be separate and apart from the TR server 112 and those systems instead being interconnected via the bus 100.

A user mobile device 114 may be configured with a mobile wallet application 116, such as Samsung Pay, Apple Pay, Google Pay, FitBit Pay, Independent mobile banking and payment applications, and third party payment applications, and/or any of various mobile banking apps for managing digital payment cards and associated accounts and information. The mobile wallet application may be adapted to store digital card information. A Software Developer Kit (SDK) 118 may be implemented, according to the disclosure, as a library of functions effecting the communications and implementing a business to payment card holder communication bridge 120. The system according to the disclosure, including the mobile device application 116 is adapted to enable user engagement using the communication bridge 120.

Aspects of the present disclosure provide for an interface, via the communication bridge 120 through the applicable API, in conjunction with the SDK integration with the wallet app, to the POS device(s) and CRM software/system(s) to enable communication between a merchant associated with the POS/CRM and the user associated with the wallet app. The disclosure provides an improved network configured to create a seamless and simple communication bridge between a merchant's CRM system with the user's digital wallet system, whether these systems are in the same company or different companies.

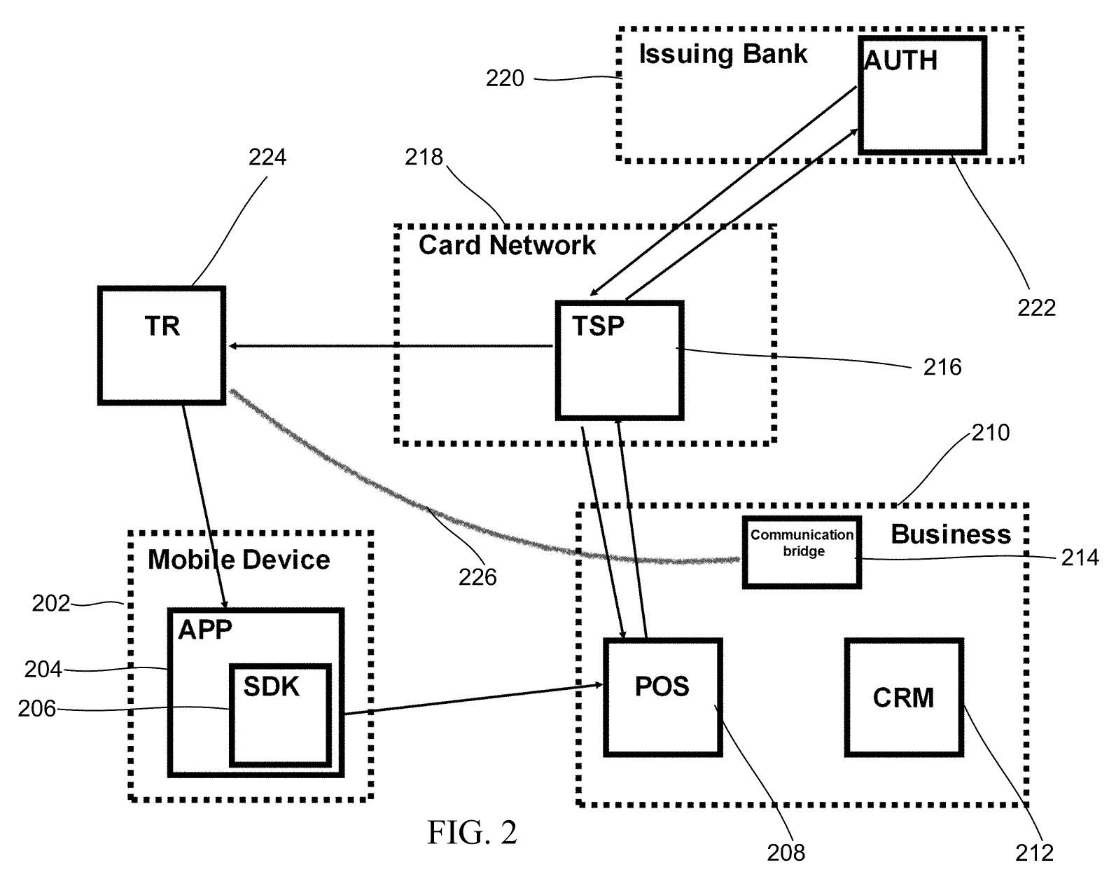

FIG. 2 is a block diagram illustrating data flow and communication between components of the system and method for improved POS and CRM network interface according to the disclosure. While some of the modules are depicted in FIG. 2 as separate and discrete modules, one of ordinary skill in the art should appreciate that the functionalities of each module may be separated or combined into any number of processing or functional modules without deviating from the scope of the disclosure.

The improved network 200 illustrated in FIG. 2 may include a mobile device 202. The mobile device 202 may include a mobile device application 204 installed on the mobile device 202. The mobile device may be an electronic device such as a cell phone, tablet, wearable intelligent device or the like. The mobile device application may be a digital wallet application, mobile banking application, or other application capable of performing a transaction using a digital card. The mobile device application 204 may incorporate a Software Development Kit (SDK) 206 that is compiled, built or included with the mobile device application software. While the SDK 206 is depicted to be a part of the mobile device application 204, one of ordinary skill in the art should appreciate that the SDK 206 may be implemented separate from the mobile device application 204 without deviating from the scope of the disclosure. For example, the SDK may be a Dynamically Linked Library (DLL), Statically Linked, or otherwise included set of functions implementing the operations described herein.

The improved network 200 may also have a Point of Sale System (POS) 208 implemented, for example as implemented within a business 210. The POS 208 is adapted to perform transactions between a user of the mobile device and the business 210. More specifically, the POS 208 is adapted to receive card data from a wallet app (including the SDK 206) implemented on the mobile device 202 at the start of a transaction. The business may also have a Customer Relationship Management system (CRM) 212. The CRM 212 may be adapted to store information associated with different payment card holders who have performed transactions with the business 210. The improved network 200 also implements a communication bridge 214. The communication bridge 214 may be a software component or module implemented on a server within the business. The communication bridge module 214 may be a portal service for the business and is adapted to control communications with various users and mobile devices.

The improved network or system 200 may further include a Token Service Provide (TSP) 216. The TSP, as known in the art, is implemented on a card network 218 and receives card data from the POS 208, converts the received tokenized card data into mapped card data associated with a card holder account, and sends the mapped card data to an issuing bank 220 for authorization of the transaction. The card network 218 involved in the improved network or system 200 according to the disclosure may be operated by one of a number of different card brands.

The issuing bank 220 interconnected in the card network 218, may have an authorization server 222 adapted to receive converted card data and transaction data and transmit an authorization response based on the received card data and transaction data to the TSP 216. The TSP 216 then transmits the authorization response to the POS 208. Further, the TSP 216 also sends a second copy that is a split, asynchronous response to a Token Requestor (TR) 224. The split, asynchronous response is also called an “out of band” response. The out of band response may include data such as a Merchant Identifier (MID), an amount of transaction, and the authorization response.

The TR 224 may act as a server for the mobile device 202 (and for a number of subscriber mobile devices that may desire access to the improved network described) and transmits the out of band response to the mobile device application 204. The TR 224 may be adapted to provision the digital card for its subscription to the improved network, and provide out of band communications within the improved network 200 after digital cards are provisioned. The TR 224 is adapted to open a communication channel 226 between the business 210 and users of mobile devices, i.e. the mobile device application 204 and the communication bridge 214. More specifically, the TR 224 is adapted to couple to the communication bridge 214. Once the TR 224 is coupled to the communication bridge 214 using the communication channel 226, the business 214 is able to transmit out of band communications to the TR 224, which then transmits the communications to the mobile device 202. Further, data does not need to be exchanged between the business' POS 208 or CRM 212 systems to communicate with the mobile device 202 and the system 200 creates a seamless and simple bridge between CRM software and systems with a digital wallet system, whether these systems are in the same company or different companies.

Additionally, the communication bridge 214 is adapted to allow the business 210 to access transactions conducted with the POS system 208 and be notified when a digital card holder/mobile device 202 with the designated TR 224 and mobile application 204 have made a transaction with the POS system 208. When the communication channel 226 is established between the TR 224 and the communication bridge 214, the TR 224 has access to each transaction performed by the POS system 208 and knows the identity of each mobile device 202 that is used to perform that transaction. Further, the TR 224 may be adapted to create a database of mobile devices 202 or user that have performed transactions with the POS system 208 and allow the business 210 to provide communications back to those mobile devices 202 or users for follow up on transactions with the business 210 where the communication flow bypasses the business' POS system 208 or CRM systems 212.

Once the mobile device application 204 receives the out of band response from the TR 224, the mobile device application 204 may be adapted to provide feedback to a user of the mobile device 202 based on the received out of band response.

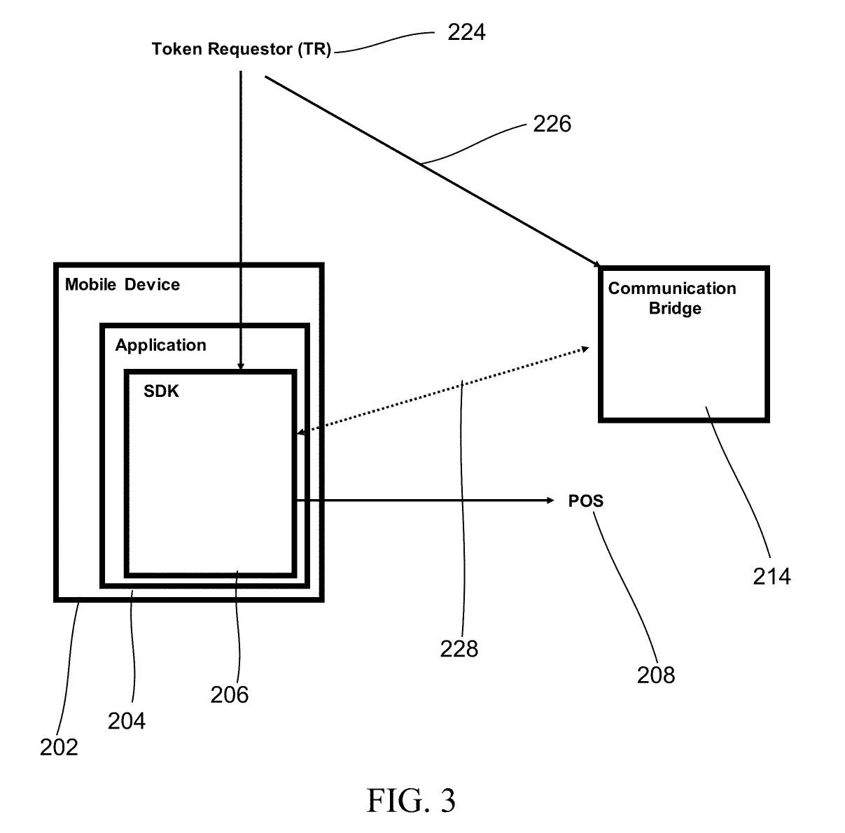

FIG. 3 is a block diagram illustrating a communication connection 228 established between the mobile device 202 and the communication bridge based on the communication channel illustrated in FIG. 2. The mobile device 202 may include the mobile device application 204 and the SDK 206 that is compiled within the mobile device application software. When a user of the mobile device 202 initiates a transaction, digital card information is transmitted to the POS system 208. The digital card information may include a tokenized card number, an expiration date of the card, a card security number such as a card verification value (CVV), track data, and EMV data associated with the card.

After the digital card information is transmitted (e.g. by NFC or MST from the user's mobile device to the POS), the mobile device application (e.g. wallet app implementing the SDK 206) receives an out of band response from the TR 224. The out of band response may include data such as a tokenized card identification, the Merchant Identifier (MID), the amount of transaction, a time stamp of the transaction, and the authorization response. The out of band response provides feedback to the card holder on the mobile device 202 about the initiated transaction. The communication bridge 208 implemented at the business 210 associated with the received MID is registered with the improved network 200. The TR 224 may be adapted to notify the communication bridge 208 of a mobile application user ID and register the user application user ID with the communication bridge 208. Once the user application user ID is registered with the communication bridge 208, the communication bridge 208 is able to communicate with the mobile device 202 using out of band communications. Further, the communication bridge does not need to exchange data between the business' POS 208 or CRM 212 systems to communicate with the mobile device 202. The improved network 200 creates a seamless and simple bridge between a businesses' CRM software and systems with a mobile device user's digital wallet system.

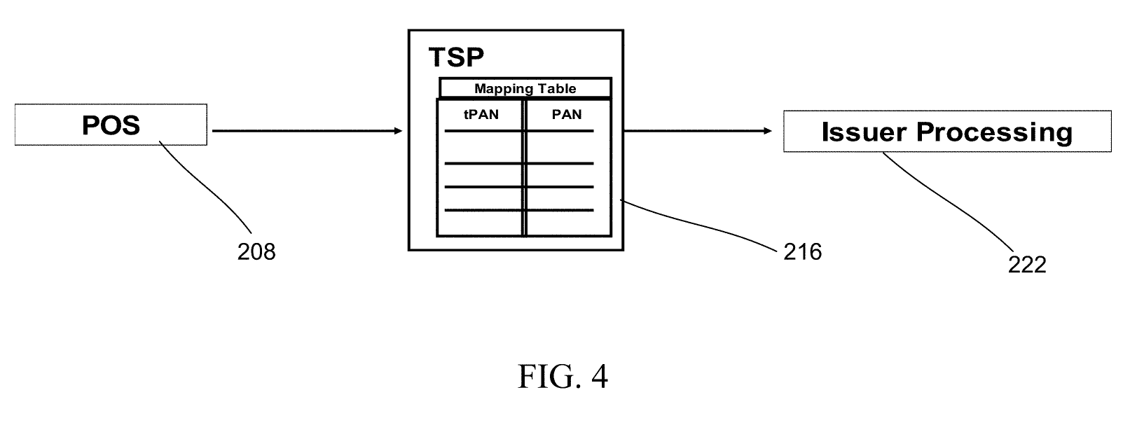

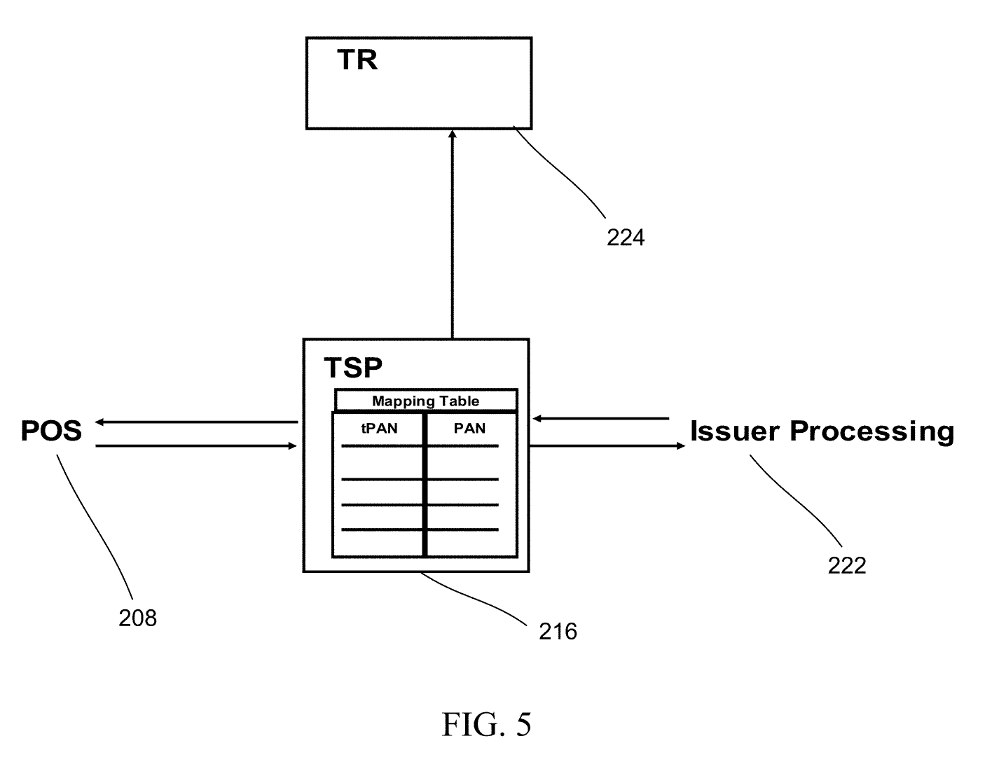

FIG. 4 is a diagram illustrating Token Service Provider (TSP) mapping of digital payment card(s) to card issuer Personal Account Number (PAN). More specifically, the POS 208 transmits a tokenized card number (tPAN), which may be a 16 digit number but is not limited thereto, to the TSP 216. The first five digits of the tokenized card number is the routing BIN for the TSP 216. Once the TSP receives the tPAN from the POS 208, the TSP 216 is adapted to map the tPAN to the corresponding PAN in the mapping table stored by the TSP 216. Once the TSP 216 has determined the corresponding PAN, the TSP 216 is adapted to transmit the PAN, which may also be a 16 digit number but is not limited thereto, to the issuing bank 220 for authorization. The first five digits of the PAN are the routing BIN for the issuing bank 220. An authorization response from the issuing bank 220 is illustrated in FIG. 5.

FIG. 5 is a diagram illustrating the TSP 216 receiving an authorization response from the issuing bank 220 for the transaction. Once the PAN is transmitted to the issuing bank 220, the issuing bank 220 may transmit an authorization response back to the TSP 216. The authorization response is an indication whether the requested transaction is approved or declined. Once the authorization response is received by the TSP 216, the TSP 216 may be configured to transmit the out of band communication to the TR 224. As previously described, the out of band communication is a split, asynchronous response separate from the synchronous response associated with the transaction. The out of band communication may include information such as the tPAN, an amount of the requested transaction, the MID, and the authorization response. The TSP 216 may also transmit the authorization response from the issuing bank 220 to the POS 208 to complete or decline the transaction. Once the TR 224 receives the out of band communication, the communication channel 226 is established between the TR 224 and the communication bridge 214, as illustrated in and described with respect to FIG. 2. The TR 224 enables the communication bridge 214 to communicate with the mobile app including the SDK 206.

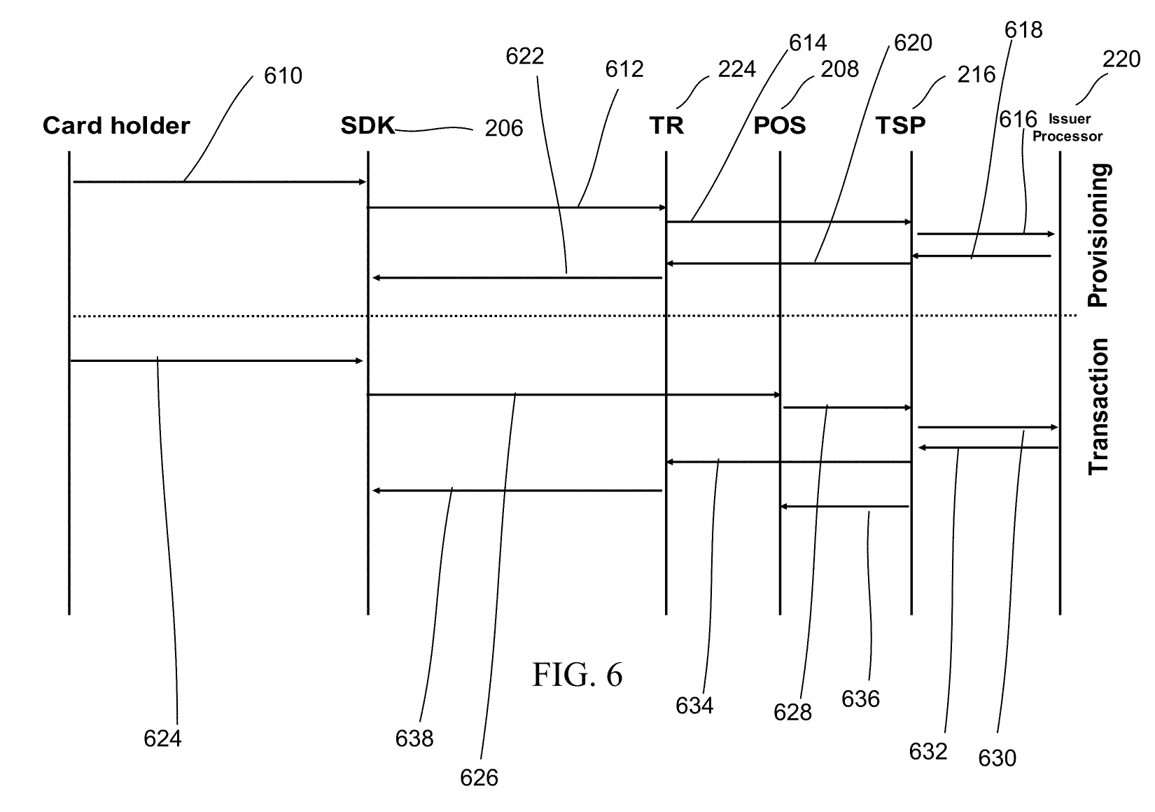

FIG. 6 is a diagram illustrating TR and SDK signal flow during provisioning of a digital card and while performing a transaction according to the disclosure. Provisioning is the process of obtaining a digital card for use with the mobile application 204. At 610, provisioning is initiated by a card holder with a request to add a digital card to the SDK 206 implemented in a mobile application 204. The request to add the digital card includes card information such as the physical card number, an expiration date of the card, and the CVV code associated with the card. At 612, the mobile app with SDK 206 may then transmit a request for a token to the TR 224 with the card information from the digital card request. At 614, the TR 224 may then transmit the request for the token to the TSP 216, the request still including the card information. At 616, the TSP 216 may then be adapted to transmit a request to tokenize the card information to the issuing bank processor 220. At 618, the issuing bank processor 220 is adapted to send a provisioning response that approves or rejects the request to tokenize the card information back to the TSP 216. At 620, when the tokenization request is approved, the TSP 216 may be adapted to transmit the tokenized card information to the TR 224. The tokenized card information may include the tokenized card number (tPAN), expiration date, and CVV code. At 622, in response to receiving the tokenized card information, the TR 224 may be adapted to transmit the tokenized card information to the SDK 206 to allow the SDK to store a digital card and the tokenized card information for future use in a transaction.

At 624, when the card holder initiates a request to perform a transaction at a POS 208, the card holder requests to perform the transaction using the mobile app (e.g. wallet app) with SDK and digital cards stored by the wallet app with SDK 206. At 626, the wallet app with SDK 206 may be adapted to transmit the tokenized card information to the POS 208 to perform the transaction using the stored digital card. After receiving the request to perform the transaction using the stored digital card with the mobile (e.g. wallet) app with the SDK 206, the POS 208 may be adapted to transmit the received tokenized card information, a transaction amount, and the merchant identifier (MID) to the TSP 216 at 628. The TSP 216 is then adapted to map the tPAN to the PAN as illustrated in FIG. 4. At 630, the TSP 216 may be adapted to transmit the mapped PAN, the card expiration date, the CVV code, the transaction amount and the MID to the issuing bank processor 220. At 632, the issuing bank processor 220 may then transmit an authorization response based on the information received from the TSP 216 back to the TSP 216. At 634 and 636, in response to receiving the authorization response from the issuing bank processor 220, the TSP 216 transmits the out of band data to the TR 224 and the authorization response to the POS 208, as illustrated in FIG. 5. Further, at 638, the TR 224 may be adapted to transmit the out of band data to the mobile app with SDK 206 to create the communication connection between the user device with the mobile app with SDK 206 and the communication bridge 214 using the TR 224, as illustrated in FIG. 3.

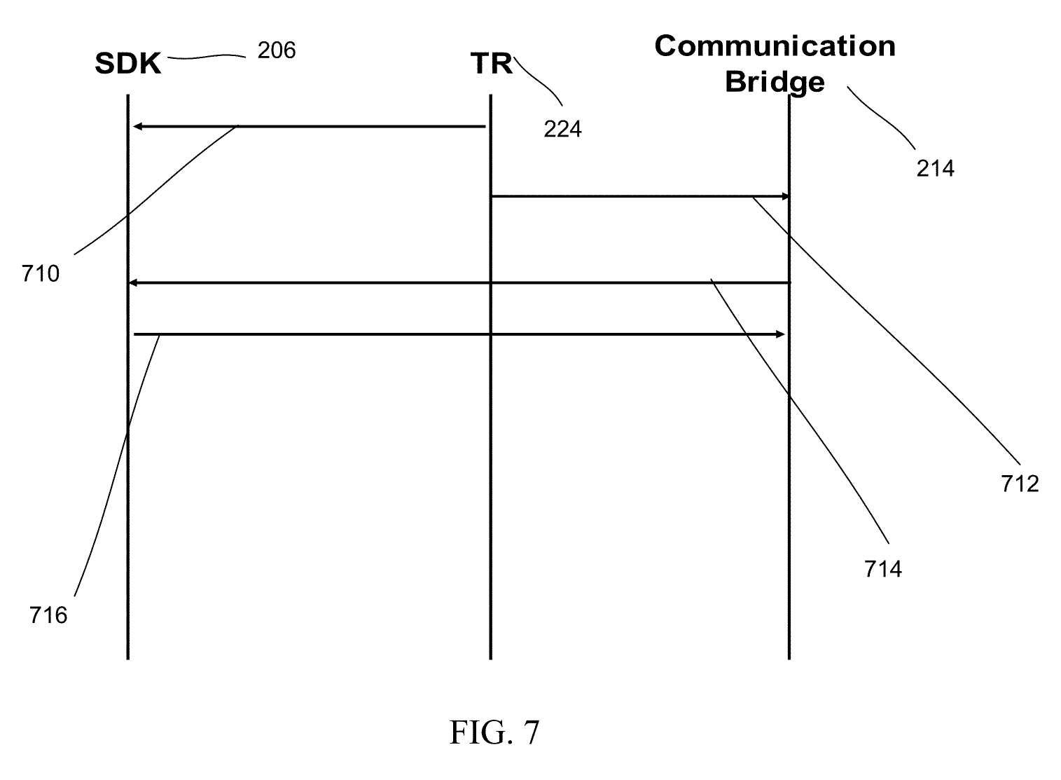

FIG. 7 is a diagram illustrating TR and communication bridge 214 signal flow to allow the communication bridge to seamlessly communicate with the mobile device app (e.g. wallet app) with SDK via the TR according to the disclosure. As described in FIG. 6, the TR 224 may be adapted to transmit the out of band communication to the mobile app with SDK 206 (shown at 710 in FIG. 7). Once the out of band communication is transmitted to the mobile app with SDK 206, the TR 224 may also transmit a notification to the communication bridge 214 when the MID (that the TR 224 received from the TSP 216) matches a communication bridge registered with TR 224 at 712. When the communication bridge 214 is notified the MID matches a registered business with a communication bridge 214, a communication channel 226 is opened between the business 210 and the mobile device/app with SDK 206. As a result, the communication bridge 208 is able to communicate with the mobile device 202 using out of band communications at 714 and 716. Further, the communication bridge does not need to exchange data between the business' POS 208 or CRM 212 systems to communicate with the mobile device 202 as the improved network 200 creates a seamless and simple bridge between the business' CRM software and mobile device(s) with digital wallet app and SDK.

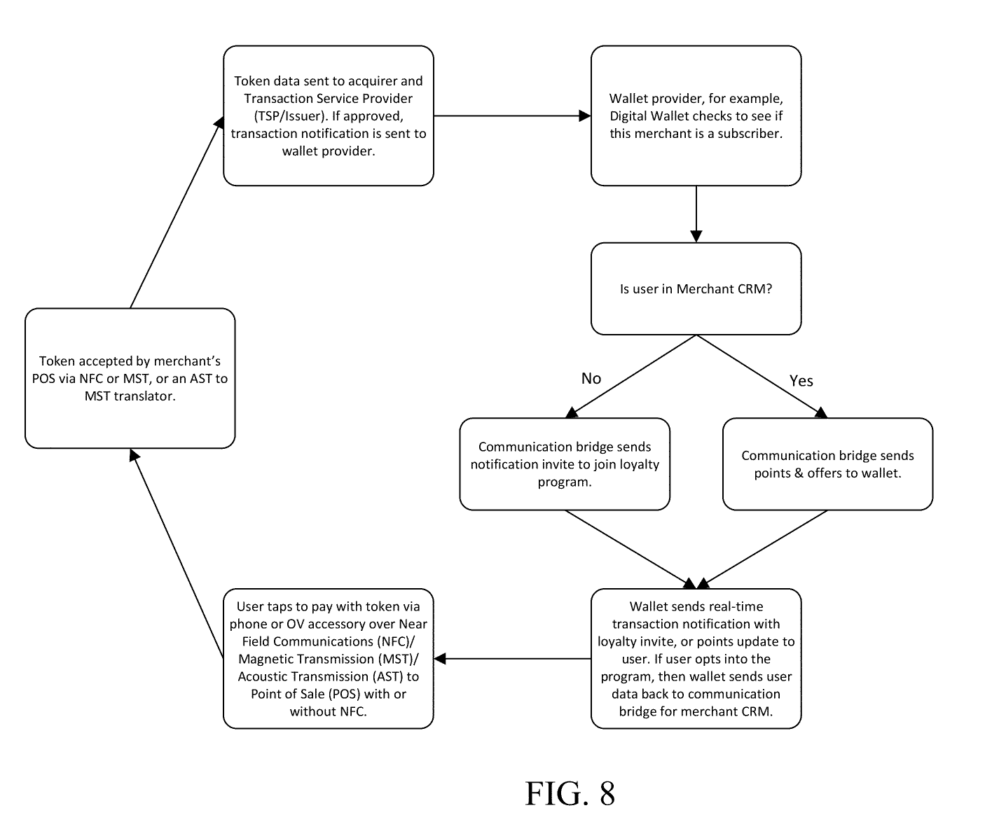

FIG. 8 illustrates a use case of how the improved network 200 and system and method according to the disclosure uniquely enables consumers to easily pay at a merchant POS and easily connect into a merchant program via a communication bridge. At block 1, a user uses a mobile device implementing a mobile wallet application, mobile banking application, or the like with an SDK to perform a transaction with a Point of Sale System (POS) using a token transmitted over Near Field Communication (NFC)/Magnetic Transmission (MST)/or Acoustic Transmission (AST). At block 2, the token is accepted by the POS. At block 3, the token data is sent to a Transaction Service Provider TSP and if the transaction is approved, a transaction notification is sent to the SDK. At block 4, the SDK determines whether the merchant has a communication bridge registered with a Token Requestor. If the communication bridge is registered with the TR, the user becomes part of the business's CRM. At block 5, whether a user has previously been registered with the communication bridge is determined. When a user has not previously been registered with the communication bridge, the communication bridge sends the user a notification to register with the communication bridge. By registering with the communication bridge, a communication channel is established between the SDK and the communication bridge. When a user had previously registered with the communication bridge, the communication bridge is able to send out of band communications to the SDK. At block 6, the SDK sends a notification using the out of band communications to the mobile device and user.

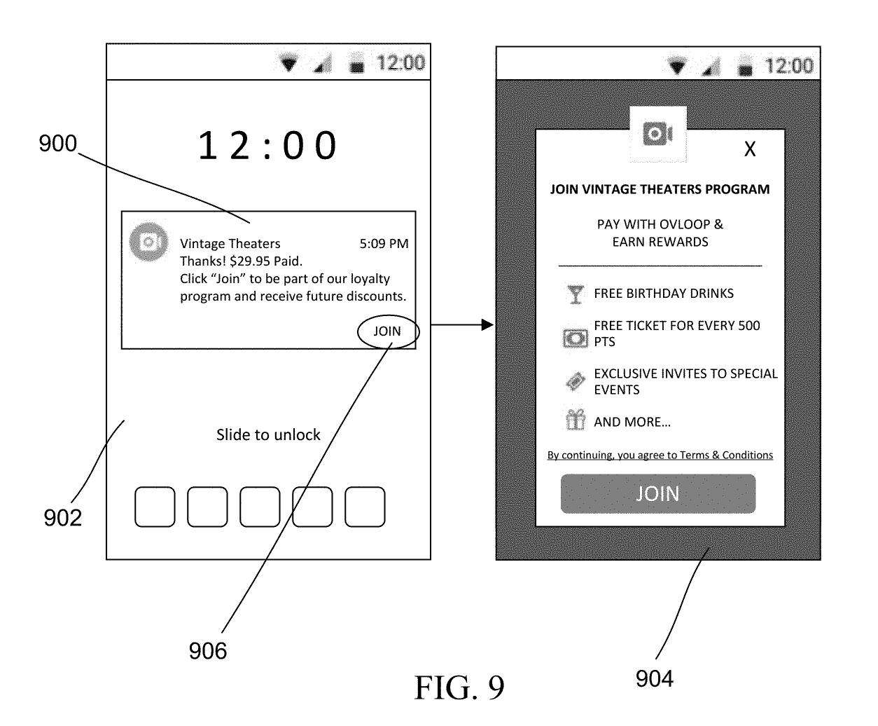

FIG. 9 depicts a notification, according to the use case of FIG. 8, appearing on a lock screen when an attempt to join a program is made and an implementation of the standard ability to open the communication bridge according to the disclosure. The notification 900 may include a “join” button 902. When a user selects the join button 902, the user is registered within a business CRM and a communication channel is opened between a Token Requestor and a business communication bridge, as described in FIG. 7.

According to the disclosure, the system and method illustrated in FIGS. 8 and 9 is implemented via an app that implements an SDK to initiate a display and response; for example, on a smartphone or tablet (mobile device). The display provides an application push notification on the mobile device, based on an event trigger that occurs when the consumer uses their mobile device/accessory (e.g. for a payment transaction at a POS). This interaction will cause a dialog to form between the consumer's smart phone device, the wallet, or any other application service running on the smart phone device with the SDK incorporated, whereby the consumer will be able to respond by two methods:
1) If the consumer is making a transaction with this merchant for the first time, a notification will appear to ask if they wish to join the merchant's program (e.g. a loyalty program for offers and other promotional information).
2) If the consumer is already a member of the merchant's program, program status will be sent via notification, and if any communications from the merchant's program are available, the consumer may be asked if they wish to receive the communications (i.e. over the communication bridge. For example, if yes and the consumer chooses to receive the communication, the consumer can hit/tap a button and display a communications with a barcode for the merchant to scan, or allow the merchant to enter a PIN on the consumer's app so that the communications can be accounted for by the merchant system, and later reconciled by the merchant—this type of system is particularly useful for small businesses that cannot afford and/or do not have access to upgrade their POS systems and still want to initiate communications with customers over an easy and efficient communication bridge.

Based on the two use cases above, the merchant will be able to:
Instantly view the communication with the user/customer and track it against a consumer's profile in the merchant's CRM.
Immediately see that a consumer has joined the merchant's loop and officially consented to begin receiving information from the merchant via the dedicated channel.
Maintain information/statistics about communications and usage of the communication bridge that the merchant implements.

The improved network and system and method according to the disclosure is designed to be an independently connected channel/service by allowing any merchant to integrate and communicate and track communications with customers via CRM, for example communications relating to offers, loyalty information and other data. The merchant always owns and can maintain their individual business and consumer information in the system; however, the strength and uniqueness of the platform may permit harnessing the combined consumer information from all merchants and all users (subscribers) in the overall system. This allows automatic triggers such as geo-location, purchase tracking, campaign monitoring, and customer interactions.

Consumers will become connected simply through an app or service that integrates the SDK or a wallet provider that integrates the SDK with functionality as described herein. The app will enable transmission of consumer preference data that they consent to provide by joining the platform and the merchant's program. For example, by engaging in the use of a mobile wallet service, the consumer becomes connected into merchants who participate in the program through add-ins, or other services.

The SDK based solution provides a system and method that provides effective integration into a multitude of different applications and services. With the consumer being able to engage through apps and connected accessories, it is possible to facilitate, monitor and enhance the merchant's interaction with this SDK and the portal (external service) they will be using.

According to the disclosure, a technical API record is implemented to pass a packet of data attributes between several data recipients (merchant, consumer, platform, wallet provider, and token service provider), the data packet will comprise:
User ID—a value to denote the unique user record on the platform—the record is still treated as a user.
Amount—this is the total amount of the transaction. This amount is passed to the platform for recording of transaction spend.
Timestamp—value recorded in UTC on the platform, to denote the date and time the transaction took place—for user display purposes this will display/convert to the time zone of the user.
Merchant ID—the unique value to denote the merchant, this is generally processor platform provided as a merchant identifier. A unique Merchant identifier is created based on multiple possible names provided by the receipt notification from Token Service Providers (TSP) and networks. To be more specific, on the receipt notifications from TSPs to wallet providers, there is a merchant name and a zip code, so that if the name is a franchise, there is a location identifier to denote which store. Furthermore each TSP may show a different merchant name based on how the TSP addresses that merchant. Thus the system and method according to the disclosure is provided wherein at the time of boarding a merchant into system, a small transaction is run on the merchant's POS terminal to communicate with the wallet app and payment device, to record the merchant names and location for a card from each TSP, so multiple merchant IDs from the wallet app can be entered into the system and be correlated to the same merchant identifier within the system. This system and method allows for any payment cards inside the wallet app to be applied to the system, instead of linking only one type of card or to a Cardlink type program.
Location—optional field may not always be populated, but in cases that it is, this provides the latitude or longitude or address of the location of the interaction.
Any transaction level details if available, such as product SKU, or other information related to product, pricing, etc.

When a merchant becomes subscriber (i.e. a member of the community that engages to have a communication bridge), either through referral from a merchant service provider (MSP) or independent sales organization (ISO) they need to establish verification of merchant account credentials to ensure that the security and authenticity of each transaction remains in place.

When the merchant on-boards as a subscriber there will be 4 steps necessary to validate the merchant information that validates their merchant ID with each of the token service providers in the US to create a Master Merchant Identifier within the system. Given that there is a Token Service Provider for each of the main card brands in the domestic US market, either the merchant or the ISO or MSP signing up the merchant will need to run a transaction for each TSP using the wallet app, and record the merchant name and zip code for each TSP, so the boarding can be completed for that merchant in the system. A special onboarding application may be used by ISO/MSP reps at the merchant location to establish proper boarding and Master Merchant Identifier in the system.

To summarize, the validation performed by the Token Service Provider is fed into the platform/system, and this is a mapping exercise to implement the TSP and merchant into the system. For example, there could be 4 TSP validations for Visa, Mastercard, Discover and American Express, performed by the ISO or MSP. The system and method according to the disclosure therefore includes the powerful TSP validation as part of on-boarding of consumer, and enables a seamless experience for each merchant payment.

In an illustrative use case of the improved network described hereinbefore for implementing a loyalty program, the inclusion of a process by which consumers can easily become connected to merchants in the system when they transact via a POS terminal, provides a painless ability for the merchant to gain consumers at the point of interaction, and to entice other consumers with the deals and offers the merchant posts into the system, so that any consumer with an SDK enabled app can see these offers, by search or location based notifications and can join the merchant's loyalty program if they want to. The improved network, system and method will help drive greater consumer to merchant engagement and loyalty, and democratize the proprietary expensive merchant-only programs so that small and medium sized merchants in the aggregate can have a powerful loyalty system with minimal cost, and offer the same type of convenient loyalty and payment experience to consumers with one app, rather than having to download many proprietary apps for each merchant.

Thus the present disclosure provides a platform and technical architecture/platform for a mobile computer device based universal customer engagement and communication channel for merchants to: offer customers a frictionless opt-in enrollment process (enrollment on consumer's mobile device) into the merchant's dedicated customer relationship management (CRM) database, through a text message or app notification to their customer's mobile device after a POS payment (using methods such as a token via a mobile payment device or mobile app, or a linked card) on the merchant's existing point of sale (POS) system; and once a customer is enrolled in the merchant's program, the system will automatically update the customer's status and send via notification the customer's status after each subsequent payment—thus payment and status is combined into one easy step, and trackable by a CRM, via the program and communication bridge, using the merchant's existing POS system and backend payment provider without change to the POS system, CRM or payment provider.

The solution provides an API or SDK interface for digital wallet providers or consumer/banking app providers to connect to the program and send transaction information (Merchant Identifier and Consumer Identifier with Transaction Amount, Type, Time, Location and other information if available) to system, and to receive status and/or merchant communications via the dedicated communication bridge, upon the payment transaction at the given merchant.

The detailed description set forth herein, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A system to enable communication between a business and a user associated with a mobile device, comprising:
a mobile device application on the mobile device, the mobile device application implementing a software development kit (SDK);
a communication bridge module adapted for communications between the communication bridge and the mobile device application implementing the software development kit (SDK); and
a token requestor (TR) communicably coupled to the communication bridge and the SDK and adapted to open an out of band communication channel between the business and the user.

2. The system of claim 1, wherein the business further implements:
a point of sale system (POS) adapted to perform transactions between the user of the mobile device and the business and receive tokenized card data from the mobile device application; and
a system adapted to store information associated with users who have performed transactions with the business.

3. The system of claim 1, further comprising:
a Token Service Provider (TSP) implemented on a card network coupled to a Point of Sale system (POS) within the business, the TSP adapted to:
receive tokenized card data from the POS;
convert the tokenized card data into mapped card data associated with a card holder account; and
transmit the mapped card data to the authorization server for authorization of the transaction.

4. The system of claim 3, further comprising an authorization server implemented by an issuing bank interconnected in the card network, the authorization server adapted to receive converted card data and transaction data and transmit an authorization response based on the received card data and transaction data.

5. The system of claim 3, wherein the TSP is further adapted to:
transmit an authorization response to the POS;
transmit an out of band response to the TR; and
open the out of band communication channel once the TR receives the out of band response.

6. The system of claim 5, wherein the out of band response includes a Merchant Identifier (MID), an amount of transaction, and the authorization response.

7. The system of claim 3, wherein the mapped card data includes a mapped account number, a card expiration date, a CVV code, a transaction amount, and a merchant identifier (MID) associated with the business.

8. The system of claim 1, wherein the communication bridge module is further adapted to transmit out of band communications to the TR; and
the TR is adapted to transmits the communications to the mobile device.

9. A method for communicating between a business and a user associated with a mobile device, comprising:
receiving a request to perform a transaction at a point of sale system (POS) of the business using a mobile device application with a software development kit (SDK) and digital cards stored by the mobile device application with SDK;
transmitting tokenized card information from the digital card to the POS to perform the transaction;
transmitting the received tokenized card information to a token service provider (TSP);
mapping the tokenized card information to card account information;
transmitting the mapped card account information to the issuing bank processor;
transmit an authorization response based on the mapped card information to the TSP; and
transmitting out of band data to the TR to open an out of band communication channel between the business and the TR.

10. The method of claim 9, wherein the out of band communication channel couples the TR to a communication bridge implemented by the business.

11. The method of claim 9, further comprising transmitting the out of band data to the mobile app with SDK to create the communication connection between the user device with the mobile app with SDK and the communication bridge using the TR.

12. The method of claim 9, wherein the tokenized card information includes a transaction amount, and a merchant identifier (MID) associated with the business.

13. The method of claim 9, wherein the mapped card information includes a mapped account number, a card expiration date, a CVV code, a transaction amount, and a merchant identifier (MID) associated with the business.

14. A system to enable communication between a business and a user associated with a mobile device, comprising:
a mobile device application on the mobile device, the mobile device application implementing a software development kit (SDK);
a communication bridge implemented within a business system of the business, the communication bridge adapted to control communications from the business;
a token requestor (TR) adapted to communicably couple to the communication bridge and the SDK to open an out of band communication channel between the business and the user;
a point of sale system (POS) adapted to perform transactions between the user of the mobile device and the business and receive tokenized card data from the mobile device application; and
a Customer Relationship management system (CRM) adapted to store information associated with users who have performed transactions with the business;
an authorization server implemented by an issuing bank interconnected in the card network, the authorization server adapted to receive converted card data and transaction data and transmit an authorization response based on the received card data and transaction data; and
a Token Service Provider (TSP) implemented on a card network coupled to a Point of Sale system (POS).

15. The system of claim 14 wherein the TSP is adapted to:
receive tokenized card data include a tokenized Personal Account Number (tPAN) from the POS;
convert the tPAN into mapped card data associated with a card holder account;
transmit the mapped card data to the authorization server for authorization of the transaction;
transmit an authorization response to the POS;
transmit an out of band response to the TR; and
open the out of band communication channel once the TR receives the out of band response.

16. The system of claim 14, wherein the tokenized card data further includes a transaction amount, and a merchant identifier (MID) associated with the business.

17. The system of claim 14, wherein the out of band response includes a Merchant Identifier (MID), an amount of transaction, and the authorization response.

18. A system implementing a consumer application enabled by a user voice response, comprising:
a processor configured for:
allowing a securely-connected accessory to transmit a token packet of consumer data to a point of sale system to enable auto-enrollment of a consumer in a merchant's loyalty program;
sending a notification from a merchant application delivering one of an offer, message or promotional coupon/voucher; and
replying to the notification through one of an audible response or text response back to the consumer application to instruct one of a payment, redemption or download of an offer from the merchant's loyalty program.
